(19) United States
(12) Patent Application Publication
(10) Pub. No.: US 2005/0217518 A1
(43) Pub. Date: Oct. 6, 2005

(54) Stencil printing machine

(76) Inventors: Taku Naitou, Ibaraki-ken (JP); Akira Nakamura, Ibaraki-ken (JP)

Correspondence Address: NATH & ASSOCIATES, PLLC;Sixth Floor, 1030 15th Street, N.W., Washington, DC, 20005, US

(21) Appl. No.: 11/098,551

(22) Filed: Apr. 5, 2005

(30) Foreign Application Priority Data
Apr. 6, 2004 (JP) P2004-111846

(51) Int. Cl. B41L 13/18

(52) U.S. Cl. 101/119

(57) ABSTRACT

A stencil printing machine, which includes: a drum which is freely rotatable and has an outer peripheral wall formed of an ink impermeable member, in which a stencil sheet is mounted on a surface of the outer peripheral wall; an ink supplying device which has an ink supply port on the outer peripheral wall of the drum, and supplies the ink, which is guided from an ink tank, from the ink supply port to the surface of the outer peripheral wall; and a pressure roller which presses a print sheet fed thereto to the outer peripheral wall. The supply tank is placed below the lowermost position of the outer peripheral wall of the drum. Moreover, a position where the ink supply port is located above a liquid level of the ink in the supply tank is set at a rotation stop position of the drum.

### BACKGROUND OF THE INVENTION

1. Field of the Invention

The present invention relates to a stencil printing machine which conveys a print medium while pressing the print medium to a drum on which a stencil sheet is mounted, and transfers an ink oozing from perforations of the stencil sheet onto the print medium.

2. Description of the Related Art

As a conventional printing method of a stencil printing machine, there are an inner press method (refer to Japanese Patent Laid-Open Publication No. Hei 7-132675 (published in 1995)) and an outer press method (refer to Japanese Patent Laid-Open Publication No. 2001-246828).

The inner press method is briefly described. As shown in FIG. 1, a drum 100 and a back press roller 101 are provided, and the drum 100 and the back press roller 101 are provided so as to be freely rotatable individually in a state where outer peripheral surfaces thereof are partially made substantially adjacent to each other. A stencil clamping portion 100a which clamps a tip end of a stencil sheet 104 is provided on the outer peripheral surface of the drum 100, and an outer peripheral wall other than the stencil clamping portion 100a is formed of a screen 102 which is flexible and ink permeable.

An ink supply mechanism 105 is provided inside the drum 100. As shown in FIG. 2, this ink supply mechanism 105 includes an inner press roller 106 which is an ink supply roller, and the inner press roller 106 is provided on a roller support member 107 so as to be freely rotatable. The inner press roller 106 is configured to be shiftable between a press position where the roller support member 107 is energized in a direction of an arrow a of FIG. 2 to press an inner peripheral surface of the screen 102 and a standby position where the roller support member 107 is rotated in a direction of an arrow b of FIG. 2 to be spaced from the inner peripheral surface of the screen 102. The inner press roller 106 is set at the press position when a print sheet 111 passes therethrough, and otherwise, set at the standby position. Moreover, the inner press roller 106 has a function to apply printing pressure from an inner periphery side of the screen 102.

The roller support member 107 is supported so as to be freely rotatable about a support shaft 108, and a doctor roller 109 and a drive rod 110 are individually provided on the roller support member 107. The doctor roller 109 has a cylindrical shape, and is fixed to the roller support member 107 at a position close to the inner press roller 106. The drive rod 110 is supported on the roller support member 107 so as to be freely rotatable, and is placed in an upper space composed of outer peripheral surfaces of the inner press roller 106 and the doctor roller 109 on sides thereof adjacent to each other. An ink 103 is supplied from an ink supply portion (not shown) to the upper space.

Next, printing operations are schematically described in order. The stencil sheet 104 on which a perforated image is formed is attached onto an outer peripheral surface of the screen 102. Then, during a printing mode, the drum 100 and the back press roller 101 are rotated in synchronization with each other in directions shown in arrows in FIG. 1, and the print sheet 111 is fed between the drum 100 and the back press roller 101.

When the print sheet 111 is fed, the inner press roller 106 presses the screen 102, and the inner press roller 106 rotates following the drum 100 in such a pressing state. The ink 103 having passed through a gap between the inner press roller 106 and the doctor roller 109 is adhered onto the outer peripheral surface of the inner press roller 106, and the ink 103 thus adhered is sequentially supplied to an inner surface of the screen 102 by the rotation of the inner press roller 106.

Moreover, when the inner press roller 106 presses the screen 102, the screen 102 swells out to the outer periphery side thereof by pressing force at this time, and the screen 102 is put into a press-contact state with the back press roller 101. Then, the print sheet 111 conveyed between the drum 100 and the back press roller 101 is conveyed while being brought into press contact with the screen 102 and the stencil sheet 104 in between the inner press roller 106 and the back press roller 101. By press-contact force at this time, the ink 103 on the screen 102 side is transferred to the print sheet 111 side from perforations of the stencil sheet 104, and an ink image is printed on the print sheet 111.

The outer press method is briefly described. As shown in FIG. 3, a drum 120 is provided. A stencil clamping portion 120a which clamps the tip end of the stencil sheet 104 is provided on an outer peripheral surface of this drum 120, and an outer peripheral wall 120b other than the stencil clamping portion 120a is formed of an ink permeable member with a porous structure.

An ink supply mechanism 125 is provided inside the drum 120. The ink supply mechanism 125 includes a squeegee roller 126 supported so as to be freely rotatable, and a doctor roller 127 placed adjacent to the squeegee roller 126. An ink 128 accumulates in an outer peripheral space surrounded by the squeegee roller 126 and the doctor roller 127. The ink 128 adhered onto the outer periphery of the rotating squeegee roller 126 passes through a gap between the squeegee roller 126 and the doctor roller 127, and thus only the ink 128 with a predetermined film thickness is adhered onto the squeegee roller 126, and the ink 128 with the predetermined film thickness is supplied to an inner surface of the outer peripheral wall 120b.

Moreover, a pressure roller 130 is provided at a position opposite to the squeegee roller 126, which is also an outside position of the drum 120. The pressure roller 130 is configured to be shiftable between a press position of pressing the outer peripheral wall 120b of the drum 120 and a standby position of being spaced from the outer peripheral wall 120b of the drum 120. The squeegee roller 126 is fixed to a support member which supports the outer peripheral wall 120b of the drum 120 so as to be freely rotatable, and an outer peripheral surface of the squeegee roller 126 and the inner peripheral surface of the outer peripheral wall 120b of the drum 120 are brought into a state of being slightly spaced from each other in a state where the outer peripheral wall 120b of the drum 120 is not pressed by the pressure roller 130. When the outer peripheral wall 120b of the drum 120 is pressed by the pressure roller 130, the outer peripheral wall 120b of the drum 120 is bent, and thus the outer peripheral surface of the squeegee roller 126 and the inner peripheral surface of the outer peripheral wall 120b of the drum 120 are brought into contact with each other.

Next, printing operations are schematically described in order. The stencil sheet 104 on which the perforated image is formed is attached onto an outer peripheral surface of the outer peripheral wall 120b of the drum 120. Then, during the printing mode, the outer peripheral wall 120b of the drum 120 is rotated in a direction shown by an arrow in FIG. 3, and the print sheet 111 is fed between the drum 120 and the pressure roller 130.

When the print sheet 111 is fed, the pressure roller 130 presses the outer peripheral wall 120b of the drum 120, and the outer peripheral wall 120b is shifted toward an inner periphery side thereof. The outer peripheral wall 120b is brought into a pressed state on the squeegee roller 126 by such shifting, and the squeegee roller 126 rotates following the drum 120. Onto the outer peripheral surface of the squeegee roller 126, the ink 128 having passed through the gap between the squeegee roller 126 and the doctor roller 127 is adhered. The ink 128 thus adhered is sequentially supplied to an inner surface of the outer peripheral wall 120b by the rotation of the squeegee roller 126.

Moreover, when the pressure roller 130 presses the outer peripheral wall 120b of the drum 120, the print sheet 111 conveyed between the drum 120 and the pressure roller 130 is conveyed while being brought into press contact with the stencil sheet 104 in between the squeegee roller 126 and the pressure roller 130. By press-contact force at this time, the ink 128 on the outer peripheral wall 120b side is transferred to the print sheet 111 side from the perforations of the stencil sheet 104, and an ink image is printed on the print sheet 111.

Incidentally, in the stencil printing machines of the conventional inner press method and outer press method, ink pools are individually formed in the outer peripheral space of the inner press roller 106 and the doctor roller 109 and in the outer peripheral space of the squeegee roller 126 and the doctor roller 127, and the inks 103 and 128 in the ink pools are supplied to the screen 102 and outer peripheral wall 120b of the drums 100 and 120 at the time of printing. Hence, when the printing is not performed for a long time, the inks 103 and 128 having accumulated in the ink pools and the inks 103 and 128 adhered onto the drums 100 and 120 and the like are left standing in a state of being in contact with the atmosphere, and there is a problem that the inks 103 and 128 are degraded.

### SUMMARY OF THE INVENTION

The applicant of the present invention has proposed a stencil printing machine, which includes: a drum which is freely rotatable and has an outer peripheral wall formed of an ink impermeable member, in which a stencil sheet is mounted on a surface of the outer peripheral wall; an ink supplying device which has an ink supply port at a position upstream of the maximum printing area of the outer peripheral wall of the drum in the printing direction, and supplies an ink from the ink supply port to the surface of the outer peripheral wall, and a pressure roller which presses a print medium fed thereto to the outer peripheral wall.

In the stencil printing machine described above, when the print medium is fed thereto in a state where the outer peripheral wall of the drum is rotated and the ink is supplied from the ink supply port to the surface of the outer peripheral wall, the print medium is conveyed while being pressed to the stencil sheet and the outer peripheral wall of the drum by the pressure roller. Meanwhile, the ink between the outer peripheral wall of the drum and the stencil sheet is diffused downstream in the printing direction while being squeezed by pressing force of the pressure roller. In addition, the ink thus diffused oozes out of perforations of the stencil sheet, and is transferred to the print sheet. In the manner described above, an ink image is printed on the print sheet. Accordingly, the ink supplied to the drum is held in a substantially hermetically sealed space between the outer peripheral wall of the drum and the stencil sheet, and is prevented from being brought into contact with the atmosphere. Hence, even if the printing is not performed for a long time, the ink can be prevented from being degraded.

However, in the above-described stencil printing machine, when the rotation of the drum is stopped at a position where the ink supply port is located below a liquid level of the ink in the supply tank, there is a possibility that the ink in the supply tank flows out of the ink supply port to the outer peripheral wall of the drum under own weight thereof, resulting in contamination of the inside of the machine.

In this connection, it is an object of the present invention to provide a stencil printing machine in which an inside is not contaminated by the ink which flows out of the ink supply port.

In order to achieve the above-described object, a first aspect of the present invention provides a stencil printing machine, which includes: a drum which is freely rotatable and has an outer peripheral wall formed of an ink impermeable member, in which a stencil sheet is mounted on a surface of the outer peripheral wall; an ink supplying device which has an ink supply port provided on the outer peripheral wall of the drum and has a supply tank storing an ink, and supplies the ink, which is guided from the supply tank, from the ink supply port to the surface of the outer peripheral wall; and a pressure roller which presses a print medium fed thereto to the outer peripheral wall, wherein the supply tank is placed below the lowermost position of the outer peripheral wall of the drum.

With the configuration described above, the ink in the supply tank never flows out of the ink supply port. Hence, the inside of the machine is not contaminated by the ink which flows out of the ink supply port after the rotation of the drum is stopped.

Moreover, a second aspect of the present invention provides a stencil printing machine, which includes: a drum which is freely rotatable and has an outer peripheral wall formed of an ink impermeable member, in which a stencil sheet is mounted on a surface of the outer peripheral wall; an ink supplying device which has an ink supply port provided on the outer peripheral wall of the drum and has a supply tank storing an ink, and supplies the ink, which is guided from the supply tank, from the ink supply port to the surface of the outer peripheral wall; and a pressure roller which presses a print medium fed thereto to the outer peripheral wall, wherein a position where the ink supply port is located above a liquid level of the ink in the supply tank is set at a rotation stop position of the drum.

With the configuration described above, the ink in the supply tank never flows out of the ink supply port. Hence, the inside of the machine is not contaminated by the ink which flows out of the ink supply port after the rotation of the drum is stopped.

In the stencil printing machine, the rotation stop position of the drum may be set at a position where the ink supply port is located slightly above the liquid level of the ink in the supply tank.

With the configuration described above, the supply tank enters a state of being filled with the ink just below the ink supply port. Accordingly, at the time of starting the next printing, the ink can be supplied rapidly from the ink supply port to the outer peripheral wall.

### BRIEF DESCRIPTION OF THE DRAWINGS

FIG. 1 is a schematic view of principal portions for printing according to an inner press method of a conventional example.

FIG. 2 is a schematic view of an ink supplying device according to the inner press method of the conventional example.

FIG. 3 is a schematic view of principal portions for printing according to an outer press method according to the conventional example.

FIG. 4 shows a first embodiment of the present invention, and is a schematic configuration view of a stencil printing machine.

FIG. 5 shows the first embodiment of the present invention, and is a perspective view of a drum.

FIG. 6 shows the first embodiment of the present invention, and is a cross-sectional view along a line 6-6 in FIG. 5.

FIG. 7 shows the first embodiment of the present invention, and is a cross-sectional view along a line 7-7 in FIG. 5.

FIG. 8 shows the first embodiment of the present invention, and is a plan view of the drum, showing an ink supply portion.

FIG. 9 shows the first embodiment of the present invention, and is a cross-sectional view along a line 9-9 in FIG. 8.

FIG. 10 shows the first embodiment of the present invention, and is a partial cross-sectional view explaining a diffusion mechanism of an ink.

FIG. 11 shows a second embodiment of the present invention, and is a perspective view of a drum.

FIG. 12 shows the second embodiment of the present invention, and is a cross-sectional view along a line 12-12 in FIG. 11.

FIG. 13 shows the second embodiment of the present invention, and is a cross-sectional view along a line 13-13 in FIG. 11.

FIG. 14 shows the second embodiment of the present invention, and is a cross-sectional view along a line 14-14 in FIG. 11.

FIG. 15 shows the second embodiment of the present invention, and is a cross-sectional view of the drum, showing a position where a rotation angle of the drum is 0 degree.

FIG. 16 shows the second embodiment of the present invention, and is a circuit block diagram of principal portions of a control system.

FIG. 17 shows the second embodiment of the present invention, and is a flowchart of operations when rotation of the drum is stopped.

FIG. 18 shows the second embodiment of the present invention, and is a time chart when printing of a set number of print sheets is completed.

FIG. 19 shows the second embodiment of the present invention, and is a time chart when a stop key is operated during a printing operation.

FIG. 20 shows a modification example of the second embodiment of the present invention, and is a cross-sectional view of the drum.

FIG. 21 shows the modification example of the second embodiment of the present invention, and is a circuit block diagram of principal portions of a control system.

FIG. 22 shows the modification example of the second embodiment of the present invention, and is a flowchart of operations when rotation of the drum is stopped.

FIG. 23 shows a third embodiment of the present invention, and is a perspective view of a drum.

FIG. 24 shows the third embodiment of the present invention, and is a cross-sectional view along a line 24-24 in FIG. 23.

FIG. 25 shows the third embodiment of the present invention, and is a cross-sectional view along a line 25-25 in FIG. 23.

FIG. 26 shows the third embodiment of the present invention, and is a cross-sectional view along a line 26-26 in FIG. 23.

FIG. 27 shows the third embodiment of the present invention, and is a cross-sectional view of the drum, showing a position where a rotation angle of the drum is 0 degree.

FIG. 28 shows the third embodiment of the present invention, and is a circuit block diagram of principal portions of a control system.

FIG. 29 shows the third embodiment of the present invention, and is a flowchart of operations when rotation of the drum is stopped.

### DETAILED DESCRIPTION OF THE PREFERRED EMBODIMENTS

Embodiments of the present invention are described below based on the drawings.

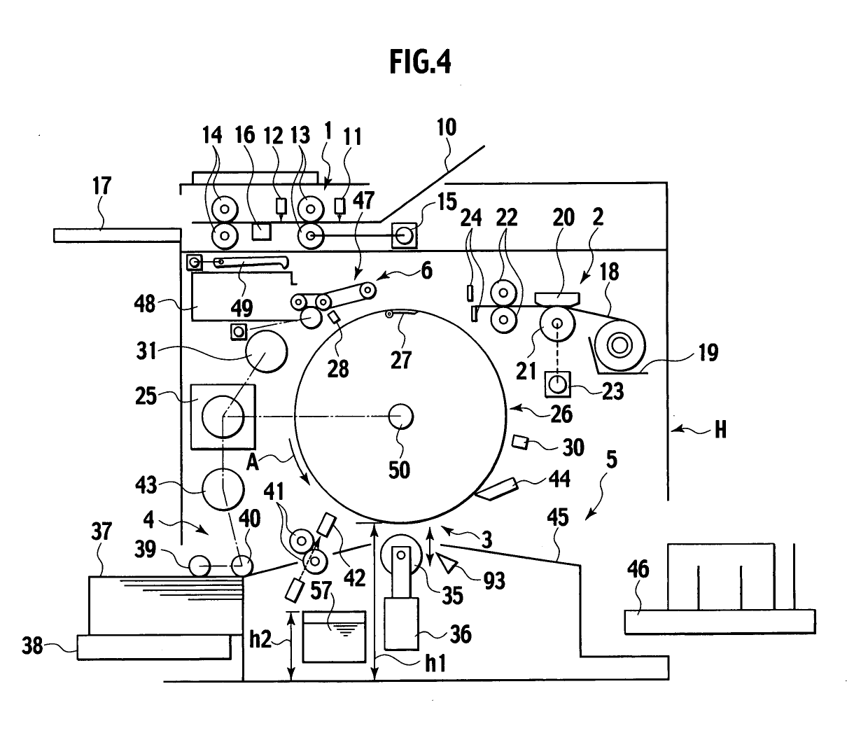

As shown in FIG. 4, a stencil printing machine is mainly composed of an original reading unit 1, a stencil making unit 2, a printing unit 3, a paper feed unit 4, a paper discharge unit 5, and a stencil disposal unit 6.

The original reading unit 1 includes an original setting tray 10 on which an original to be printed is mounted, reflective-type original sensors 11 and 12 which detect the presence of the original on the original setting tray 10, original conveyer rollers 13 and 14 which convey the original on the original setting tray 10, a stepping motor 15 which rotationally drives the original conveyer rollers 13 and 14, a contact image sensor 16 which optically reads image data of the original conveyed by the original conveyer rollers 13 and 14 and converts the read data into electrical signals, and an original discharge tray 17 on which the original discharged from the original setting tray 10 is mounted. The original mounted on the original setting tray 10 is conveyed by the original conveyer rollers 13 and 14, and the image sensor 16 reads the image data of the conveyed original.

The stencil making unit 2 includes a stencil housing 19 which houses a long and rolled stencil sheet 18, a thermal print head 20 placed downstream of the stencil housing 19 in a conveying direction, a platen roller 21 placed at a position opposite to the thermal print head 20, a pair of stencil transfer rollers 22 and 22 placed downstream of the platen roller 21 and the thermal print head 20 in the conveying direction, a write pulse motor 23 which rotationally drives the platen roller 21 and the stencil transfer rollers 22 and 22, and a stencil cutter 24 placed downstream of the pair of stencil transfer rollers 22 and 22 in the conveying direction.

The long stencil sheet 18 is conveyed by the rotation of the platen roller 21 and the stencil transfer rollers 22 and 22. Based on the image data read by the image sensor 16, each of dot-shaped heating elements of the thermal print head 20 selectively performs a heating operation, and thus the stencil sheet 18 is perforated due to thermal sensitivity thereof to make a stencil. Then, the stencil sheet 18 thus made is cut by the stencil cutter 24 to make the stencil sheet 18 with a predetermined length.

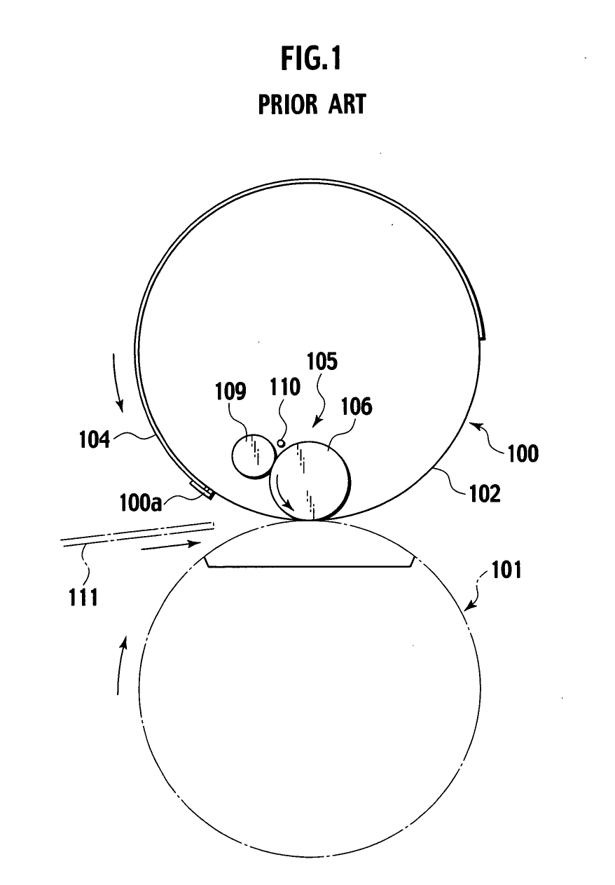

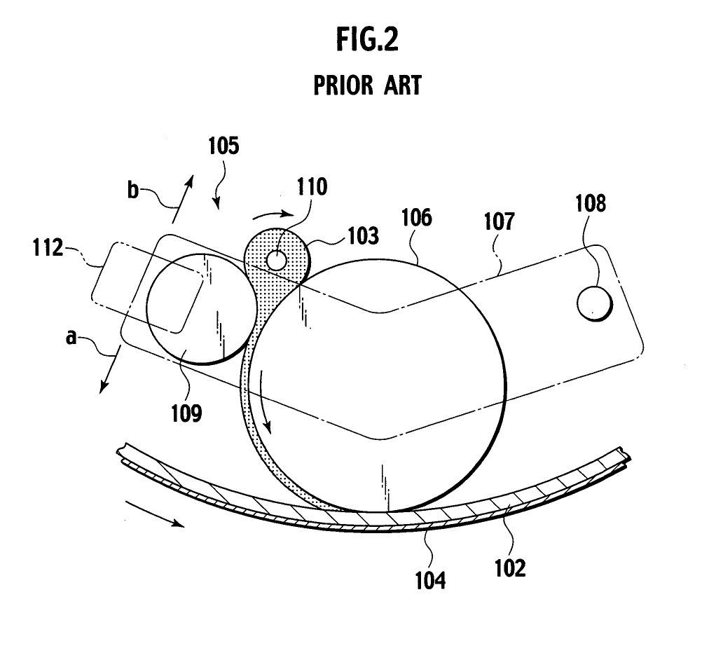

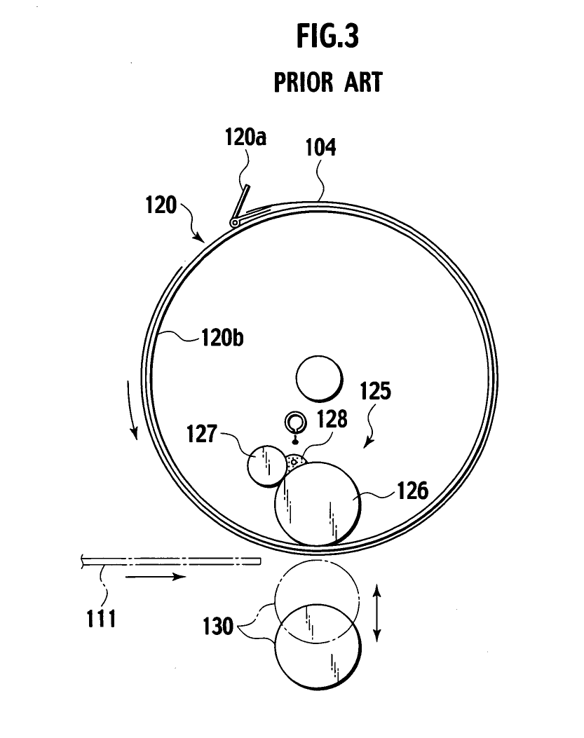

The printing unit 3 includes a drum 26 which rotates in a direction of an arrow A of FIG. 1 by driving force of a main motor 25, a stencil clamping portion 27 which is provided on an outer peripheral surface of the drum 26 and clamps a tip end of the stencil sheet 18, and an ink supplying device 54A which supplies an ink 56 to the surface of the drum 26.

Moreover, the printing unit 3 includes a stencil confirming sensor 28 which detects whether or not the stencil sheet 18 is wound and attached around the outer peripheral surface of the drum 26, a reference position detecting sensor 30 which detects a reference position of the drum 26, and a rotary encoder 31 which detects rotation of the main motor 25. Based on a detection output of the reference position detecting sensor 30, a pulse outputted from the rotary encoder 31 is detected, thus enabling a rotation position of the drum 26 to be detected.

Furthermore, the printing unit 3 includes a pressure roller 35 placed below the drum 26. The pressure roller 35 is constructed to be shiftable between a press position of pressing the outer peripheral wall of the drum 26 by driving force of a solenoid device 36 and a standby position of being spaced from the outer peripheral surface of the drum 26. The pressure roller 35 is always located at the press position during a period of a printing mode (including a trial print mode) and located at the standby position during a period other than the period of the printing mode.

Then, the tip end of the stencil sheet 18 conveyed from the stencil making unit 2 is clamped by the stencil clamping portion 27, and the drum 26 is rotated in such a clamping state, so that the stencil sheet 18 is wound and attached around the outer peripheral surface of the drum 26. Then, print sheets (print media) 37, which are fed by the paper feed unit 4 in synchronization with the rotation of the drum 26, are pressed to the stencil sheet 18 wound around the drum 26 by the pressure roller 35. Thus, an ink 56 is transferred from perforations of the stencil sheet 18 onto the print sheets 37, and an image is printed thereon.

The paper feed unit 4 includes a paper feed tray 38 on which the print sheets 37 are stacked, first paper feed rollers 39 and 40 which convey only the uppermost print sheet 37 from the paper feed tray 38, a pair of second paper feed rollers 41 and 41 which convey the print sheet 37, which has been conveyed by the first paper feed rollers 39 and 40, between the drum 26 and the pressure roller 35 in synchronization with the rotation of the drum 26, and a paper feed sensor 42 which detects whether or not the print sheet 37 has been conveyed between the pair of second paper feed rollers 41 and 41. The first paper feed rollers 39 and 40 are constructed such that the rotation of the main motor 25 is selectively transmitted thereto through a paper feed clutch 43.

The paper discharge unit 5 includes a sheet separator claw 44 which separates the printed print sheets 37 from the drum 26, a paper discharge sensor 93 which detects whether or not the print sheets 37 have been discharged from the drum 26, a conveying passage 45 through which the print sheets 37 separated from the drum 26 by the sheet separator claw 44 are conveyed, and a paper receiving tray 46 on which the print sheets 37 discharged from the conveying passage 45 are mounted.

The stencil disposal unit 6 includes disposed stencil conveying device 47, a stencil disposal box 48, and a disposed stencil compression member 49. The disposed stencil conveying device 47 guides the tip end of the stencil sheet 18, of which clamping has been released from the outer peripheral surface of the drum 26, and conveys the used stencil sheet 18 thus guided while peeling off the same stencil sheet 18 from the drum 26. The stencil disposal box 48 houses the stencil sheet 18 conveyed by the disposed stencil conveying device 47. The disposed stencil compression member 49 pushes the stencil sheet 18, which has been conveyed by the disposed stencil conveying device 47 into the stencil disposal box 48, into a bottom of the stencil disposal box 48.

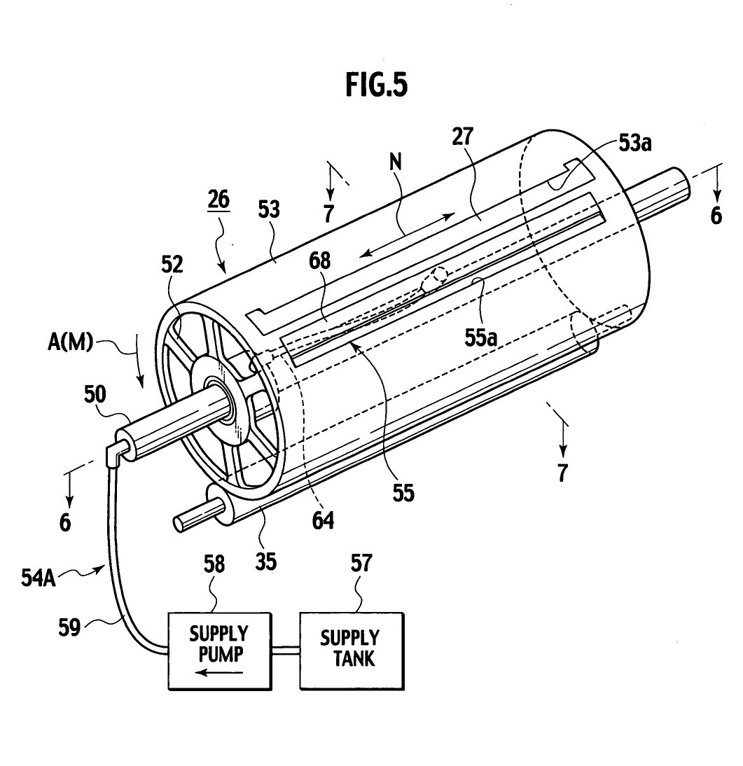

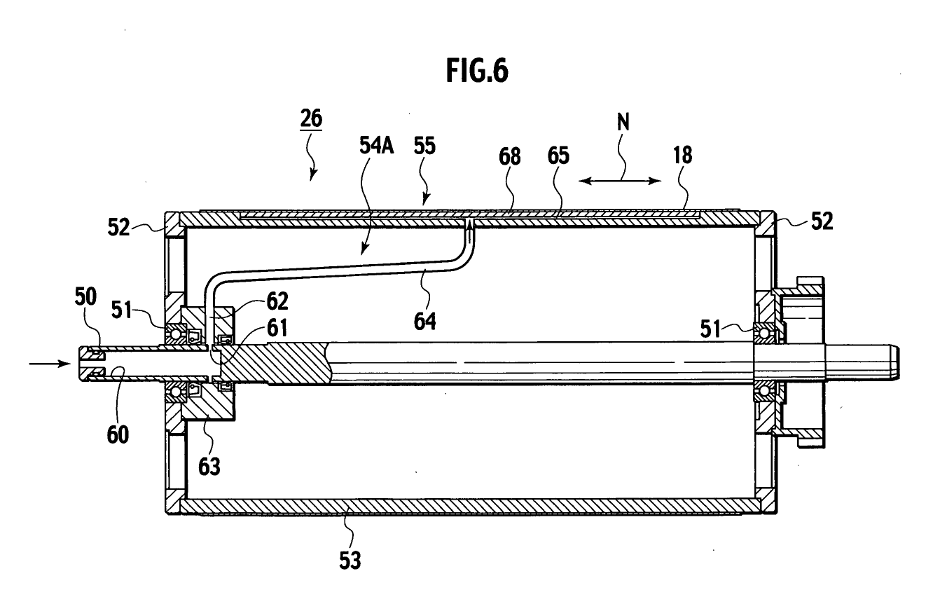

As shown in FIG. 5 to FIG. 7, the drum 26 includes a support shaft 50 fixed to a machine body H (shown in FIG. 4), a pair of side disks 52 and 52 supported on the support shaft 50 so as to be freely rotatable with bearings 51 interposed therebetween, respectively, and a cylindrical outer peripheral wall 53 fixed between the pair of side disks 52 and 52. The outer peripheral wall 53 is rotationally driven by rotation force of the main motor 25 integrally with the pair of side disks 52 and 52. Moreover, the outer peripheral wall 53 has enough rigidity not to be deformed when being brought into press-contact with the pressure roller 35, and is formed of an ink impermeable member which does not allow the ink 56 to permeate therethrough. Note that, depending on a type of the ink impermeable member, the outer peripheral surface of the outer peripheral wall 53 may be subjected to various kinds of surface processing known in public, such as a fluorine-contained resin coating process such as a Teflon® coating process, nickel plating, nickel chromium plating, fused zinc plating and anodic treatment for the purpose of forming the outer peripheral surface concerned into an even cylindrical surface.

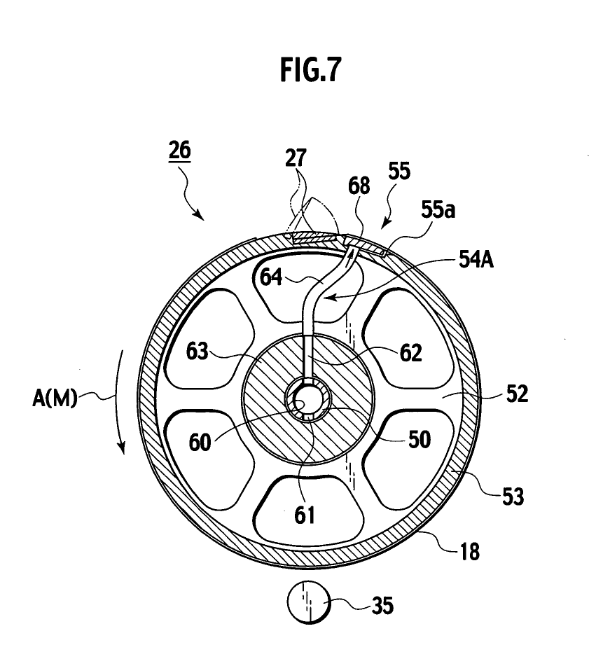

The stencil clamping portion 27 is provided by use of a concave clamping portion 53a formed on the outer peripheral wall 53 along an axial direction of the support shaft 50. One end of the stencil clamping portion 27 is supported on the outer peripheral wall 53 such that the stencil clamping portion 27 is freely rotatable. The stencil clamping portion 27 is provided so as not to protrude from the outer peripheral wall 53 in a clamping state shown by a solid line in FIG. 7 while the stencil clamping portion 27 protrudes from the outer peripheral wall 53 in a clamping release state shown by a virtual line in FIG. 7. Hence, the stencil clamping portion 27 is configured to be capable of clamping the stencil sheet 18 without protruding from the outer peripheral wall 53.

The outer peripheral wall 53 is rotated in the direction of the arrow A of FIG. 5 and FIG. 7, and a position thereof rotated a little from the stencil clamping portion 27 is set at a printing start point. Hence, the rotation direction A becomes a printing direction M, and an area that follows the printing start point is set as a printing area. In this first embodiment, the maximum printing area is set at a region sufficient for printing an A3-size sheet. Moreover, an ink supply portion 55 of the ink supplying device 54A is provided upstream of the outer peripheral wall 53 in the printing direction M.

As shown in FIG. 5 to FIG. 9, the ink supplying device 54A includes a supply tank 57 in which the ink 56 is stored, a supply pump 58 which suctions the ink 56 in the supply tank 57, a first pipe 59 which supplies the ink 56 suctioned by the supply pump 58, the support shaft 50 to which the other end of the first pipe 59 is connected and in which an ink passage 60 is formed and a hole 61 is formed at a position 180 degrees opposite thereto, a rotary joint 63 which is supported on an outer periphery of the support shaft 50 so as to be freely rotatable and in which a through hole 62 that is able to communicate with the hole 61 is formed, a second pipe 64 in which one end thereof is connected to the rotary joint 63 and the other end thereof is guided to the outer peripheral wall 53, and the ink supply portion 55 to which the other end of the second pipe 64 is made open.

As shown in FIG. 4, the supply tank 57 is placed at a position in the machine body H, which is below the lowermost position of the outer peripheral wall 53 of the drum 26. Specifically, when height from a lower surface of the machine body H to the lowermost position of the outer peripheral wall 53 of the drum 26 is defined as h1, and height from the lower surface of the machine body H to an upper surface of the supply tank 57 is defined as h2, the supply tank 57 is placed at a position satisfying h2<h1.

As shown in FIG. 5 to FIG. 9, the ink supply portion 55 is composed of an ink diffusion groove 65 which diffuses the ink 56 from the second pipe 64 in a perpendicular-to-printing direction N, plural communication holes 66 made open at an interval to the ink diffusion groove 65 in the perpendicular-to-printing direction N, and the ink supply port 55a as an ink diffusion/supply portion which communications with the plural communication holes 66 and is made open to the surface of the outer peripheral wall 53.

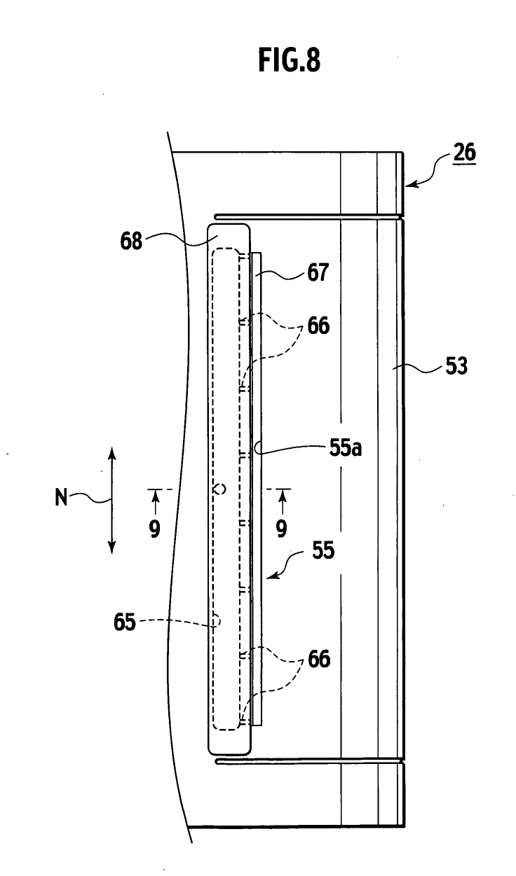

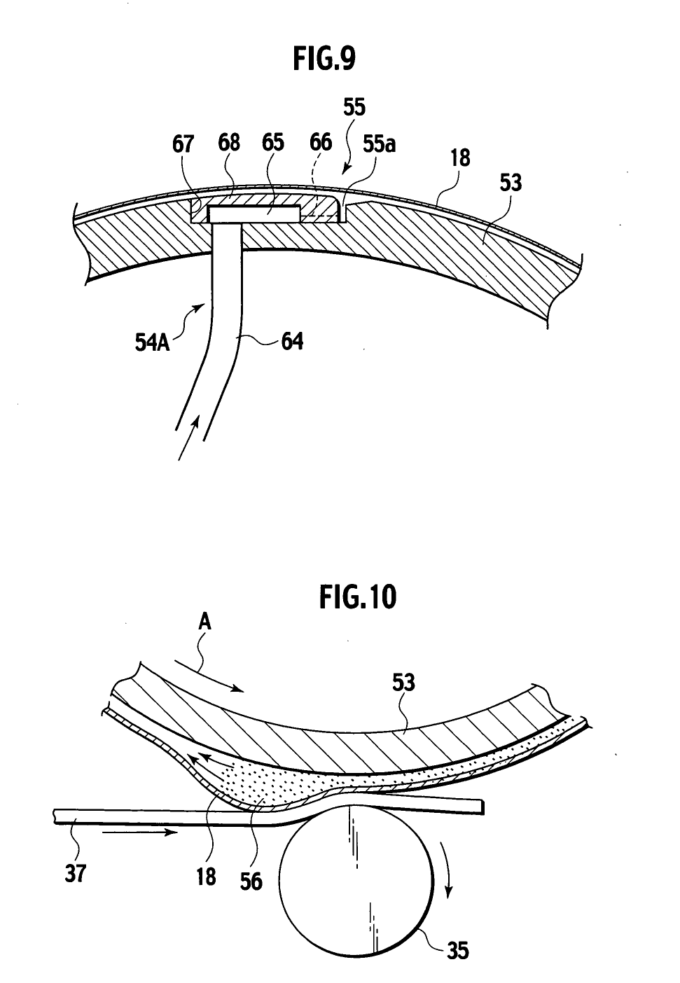

As shown in FIG. 8 and FIG. 9, the ink diffusion groove 65, the plural communication holes 66 and the ink supply port 55a are formed of an ink supplying concave portion 67 formed along a direction perpendicular to the printing direction M (that is, perpendicular-to-printing direction N) of the outer peripheral wall 53, and of an ink distribution member 68 placed inside the ink supplying concave portion 67. The ink supply port 55a is continuously formed along the perpendicular-to-printing direction N, and configured to supply the ink 56 substantially evenly in the perpendicular-to-printing direction N of the outer peripheral wall 53.

Here, the placed position of the ink supply portion 55 may be any of a position upstream of the maximum printing area in the printing direction, a position on a border partitioning the maximum printing area and a non-printing area further upstream thereof, and an upstream position in the printing direction in the maximum printing area. Note that, when the ink supply portion 55 is placed at the position upstream of the maximum printing area in the printing direction, the placed position thereof is set at a position downstream of the stencil clamping portion 27 in the printing direction. Moreover, when the ink supply portion 55 is placed in the maximum printing area, the placed position thereof is set at a position where the ink 56 supplied to the surface of the outer peripheral wall 53 is at least diffusible onto the border partitioning the maximum printing area and the non-printing area further upstream thereof.

Next, operations of the stencil printing machine configured as described above are briefly described.

First, when a stencil making mode is selected, in the stencil making unit 2, the stencil sheet 18 is conveyed by the rotation of the platen roller 21 and the stencil transfer rollers 22 and 22. Based on the image data read by the original reading unit 1, a large number of heating elements of the thermal print head 20 selectively perform the heating operation, and thus the stencil sheet 18 is perforated due to the thermal sensitivity thereof to make the stencil. Then, the stencil sheet 18 thus made is cut at the predetermined spot by the stencil cutter 24. Thus, the stencil sheet 18 with the desired dimension is made.

In the printing unit 3, the tip end of the stencil sheet 18 made in the stencil making unit 2 is clamped by the stencil clamping portion 27 of the drum 26, and the drum 26 is rotated in such a clamping state, so that the stencil sheet 18 is wound, attached and loaded around the outer peripheral surface of the drum 26.

Next, when the printing mode is selected, in the printing unit 3, the drum 26 is rotationally driven, and the supply pump 58 of the ink supplying device 54A starts driving. Then, the ink 56 in the supply tank 57 is guided to the ink supply port 55a, and the ink 56 is supplied to the outer peripheral wall 53 from the ink supply port 55a. The ink 56 thus supplied is held between the outer peripheral wall 53 and the stencil sheet 18, and the pressure roller 35 is shifted from the standby position to the press position.

The paper feed unit 4 feeds the print sheets 37 between the drum 26 and the pressure roller 35 in synchronization with the rotation of the drum 26. The print sheets 37 thus fed are pressed to the outer peripheral wall 53 of the drum 26 by the pressure roller 35, and conveyed by the rotation of the outer peripheral wall 53 of the drum 26. Specifically, the print sheets 37 are conveyed while being brought into intimate contact with the stencil sheet 18.

Moreover, at the same time when the print sheets 37 are conveyed, as shown in FIG. 10, the ink 56 held between the outer peripheral wall 53 of the drum 26 and the stencil sheet 18 is diffused downstream in the printing direction M while being squeezed by the pressing force of the pressure roller 35. The ink 56 thus diffused oozes out of the perforations of the stencil sheet 18, and is transferred to the print sheets 37. In the manner described above, the ink image is printed on the print sheets 37 in the process where the print sheets 37 pass between the outer peripheral wall 53 of the drum 26 and the pressure roller 35. With regard to the print sheets 37 which have come out from between the outer peripheral wall 53 of the drum 26 and the pressure roller 35, the tip ends thereof are peeled off from the drum 26 by the sheet separator claw 44. The print sheets 37 spaced from the drum 26 are discharged through the conveying passage 45 to the paper receiving tray 46, and are stacked there.

When printing of the set number of print sheets is completed, the pressure roller 35 is returned back to the standby position from the press position, and the drive of the supply pump 58 of the ink supplying device 54A is stopped. In addition, the rotation of the outer peripheral wall 53 of the drum 26 is stopped, and the printing stencil machine enters a standby mode. Moreover, not only in the case as described above where the printing of the set number of print sheets is completed, but also in the case where the printing is forcibly stopped by an instruction of a user (operation of a stop key) and the like, the stencil printing machine enters the standby mode according to similar operations to the above.

When making of a new stencil sheet is started and so on and stencil disposal processing is thus started, the stencil clamping portion 27 of the drum 26 is shifted to a clamping release position, and the tip end of the stencil sheet 18, of which clamping has been released, is guided to the disposed stencil conveying device 47, following the rotation of the drum 26, and housed in the stencil disposal box 48.

As described above, in the stencil printing machine of this embodiment, the supply tank 57 is placed at the position below the lowermost position of the outer peripheral wall 53 of the drum 26. Accordingly, at whichever position the rotation of the drum 26 may be stopped, the ink 56 in the supply tank 57 never flows out of the ink supply port 55a under own weight thereof. Hence, the inside of the machine is not contaminated by the ink 56 which flows out of the ink supply port 55a after the rotation of the drum 26 is stopped.

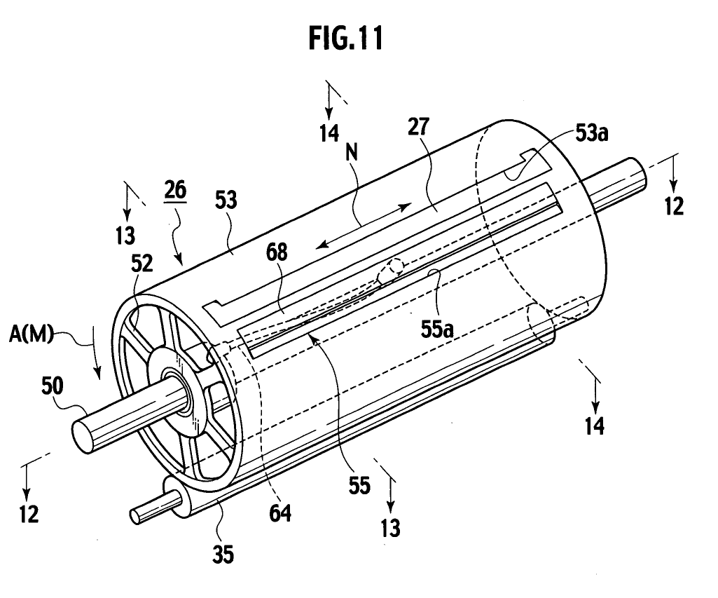

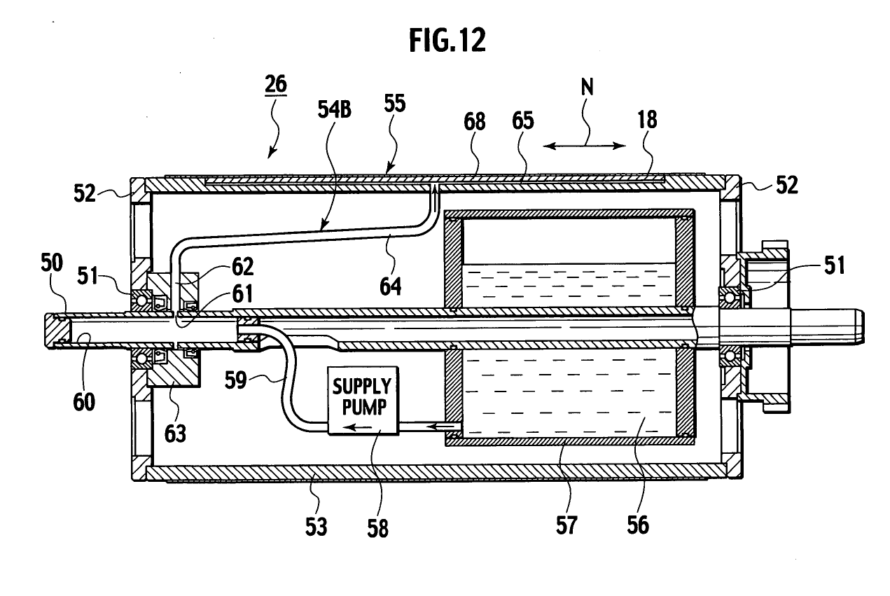

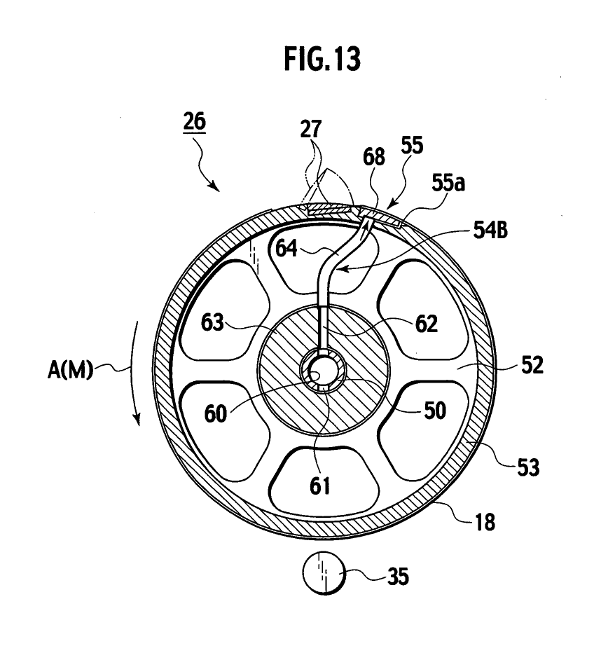

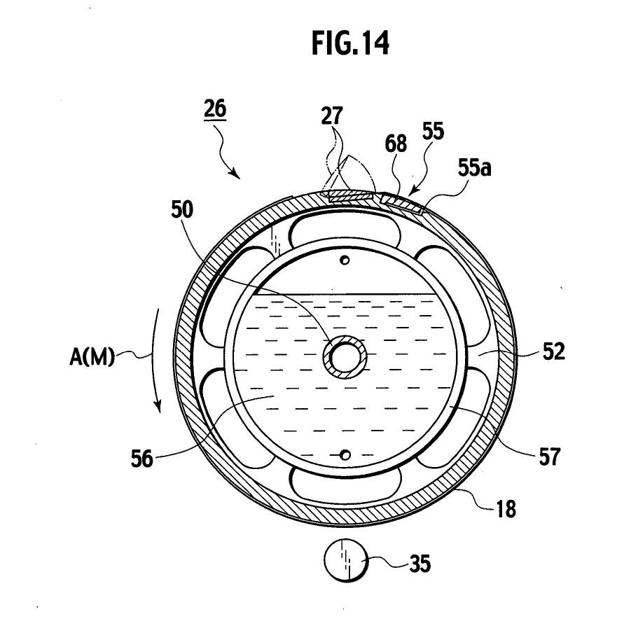

FIG. 11 to FIG. 19 show a second embodiment of the present invention.

In FIG. 11 to FIG. 19, when this second embodiment is compared with the first embodiment, the second embodiment is different from the first embodiment only in a configuration of an ink supplying device 54B and control contents at the time when the drum is stopped. Other configurations of the second embodiment are the same as those of the first embodiment. Accordingly, the same reference numerals are assigned to the same constituent portions, and detailed description thereof is omitted.

Specifically, as shown in FIG. 11 to FIG. 14, the ink supplying device 54B includes a supply tank 57 which is housed in the drum 26 and in which the ink 56 is stored, a supply pump 58 which is housed in the drum 26 and suctions the ink 56 in the supply tank 57, a first pipe 59 which supplies the ink 56 suctioned by the supply pump 58 and is placed in the drum 26, a support shaft 50 to which the other end of the first pipe 59 is connected and in which an ink passage 60 is formed and a hole 61 is formed at a position 180 degrees opposite thereto, a rotary joint 63 which is supported on an outer periphery of the support shaft 50 so as to be freely rotatable and in which a through hole 62 that is able to communicate with the hole 61 is formed, a second pipe 64 in which one end thereof is connected to the rotary joint 63 and the other end thereof is guided to the outer peripheral wall 53, and an ink supply portion 55 to which the other end of the second pipe 64 is made open. Specifically, unlike those of the ink supplying device 54A of the first embodiment, all the parts of the ink supplying device 54B are housed in the drum 26. The supply tank 57 has a cylindrical shape, and is placed so that the support shaft 50 penetrates through a center of the cylindrical shape. A configuration of the ink supply portion 55 is the same as that of the first embodiment.

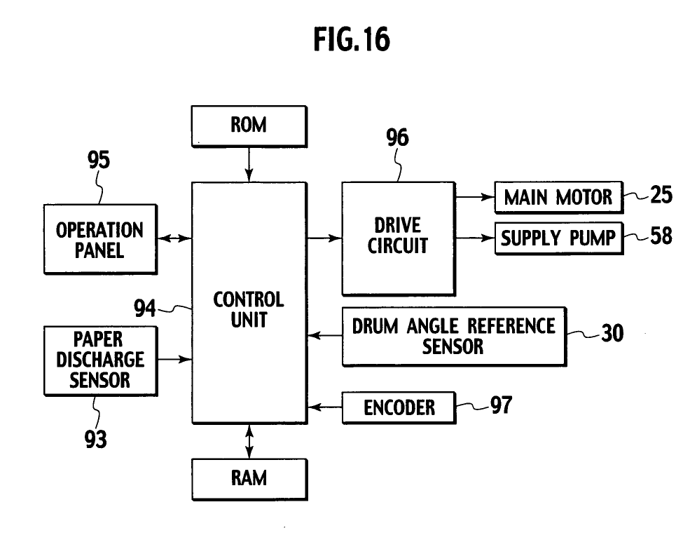

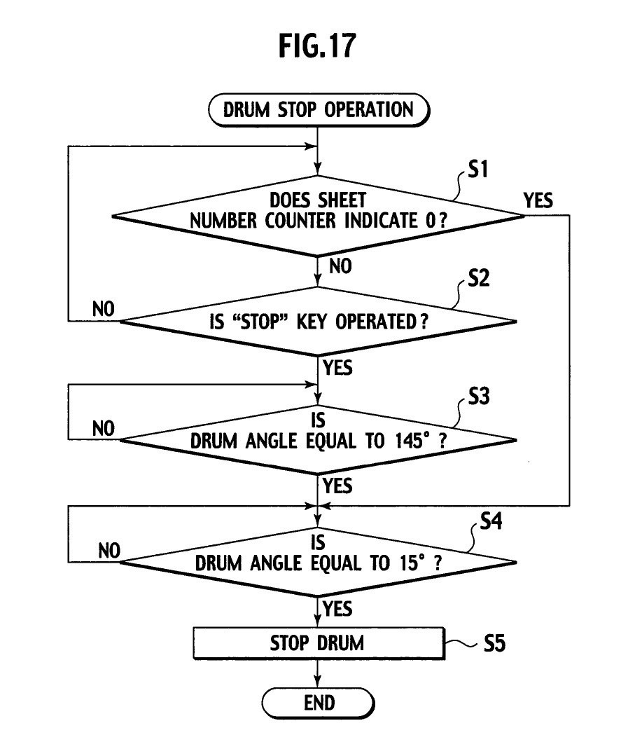

Next, a control system is briefly described. As shown in FIG. 16, a control unit 94 receives a command signal from an operation panel 95 and sensor outputs from the paper discharge sensor 93, the drum angle reference sensor 30 and the like, and drives the main motor 25, the supply pump 58 and the like through a drive circuit 96 in order to execute the printing operation, the stencil making operation, the stencil disposal operation and the like based on the signals thus received. Moreover, in the operation of stopping the rotation of the drum 26, a flow shown in FIG. 17 is executed. The control contents when the rotation is stopped are described below in paragraphs which describe functions of this embodiment.

On the operation panel 95, a ten key, a printing/stencil making mode selection key, a start key, a stop key and the like are provided.

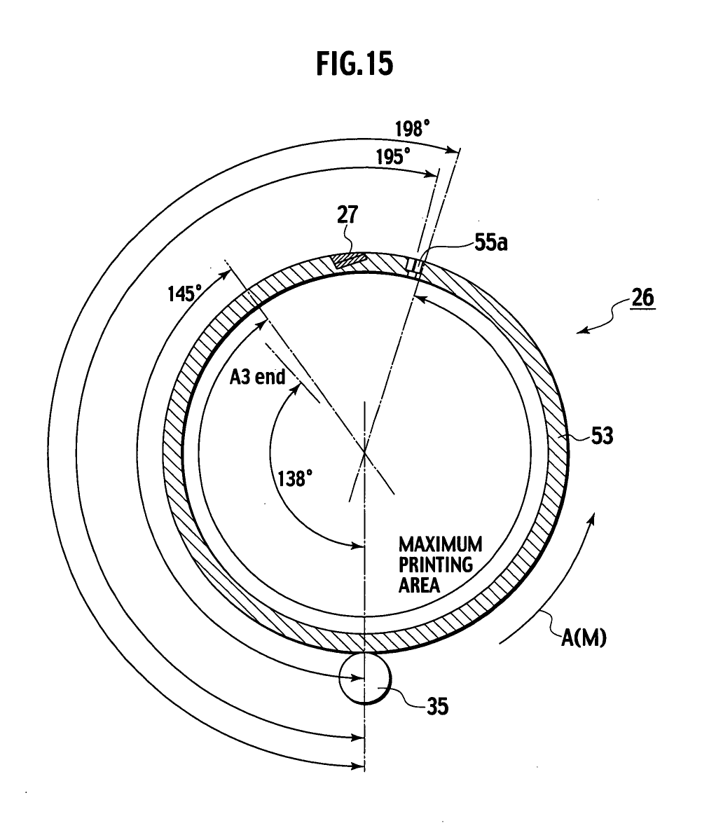

Moreover, the control unit 94 can detect a rotation angle of the drum 26 based on the sensor output of the drum angle reference sensor 30 and an output of an encoder 97. With regard to the rotation angle of the drum 26, a drum position shown in FIG. 15 shows a reference position of which angle is 0 degree. At a rotation position of 145 degrees, an end position of the maximum printing area is opposed to the pressure roller 35. At a rotation position of 195 degrees, the ink supply port 55a is opposed to the pressure roller 35. At a rotation position of 15 degrees, the ink supply port 55a is placed at the uppermost position of the outer peripheral wall 53 of the drum 26.

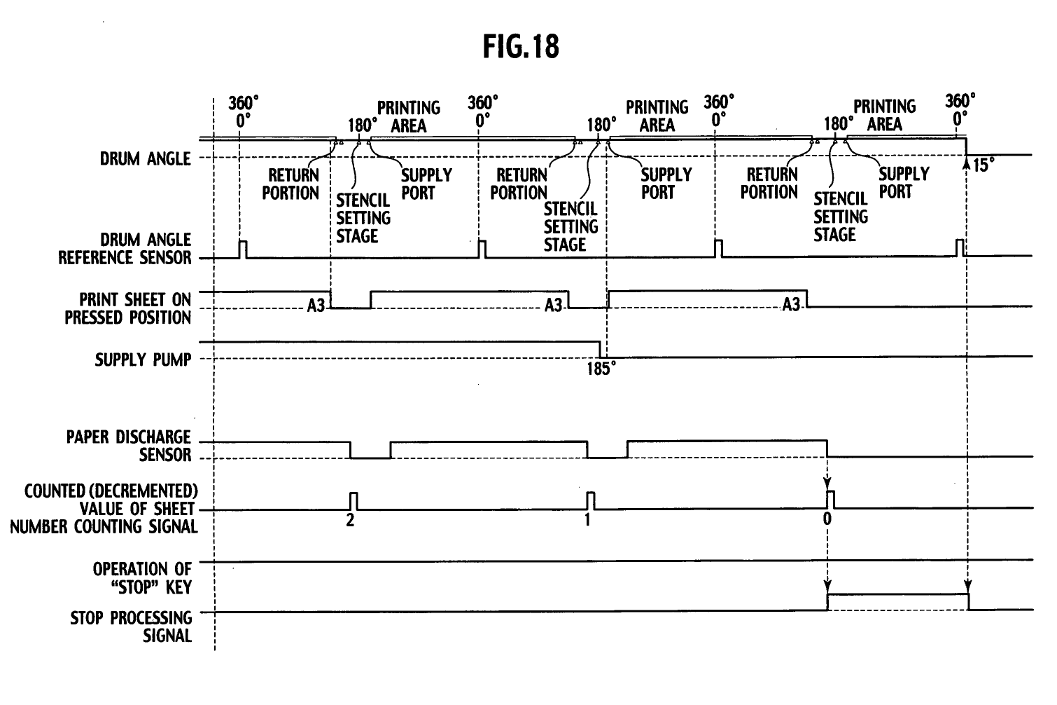

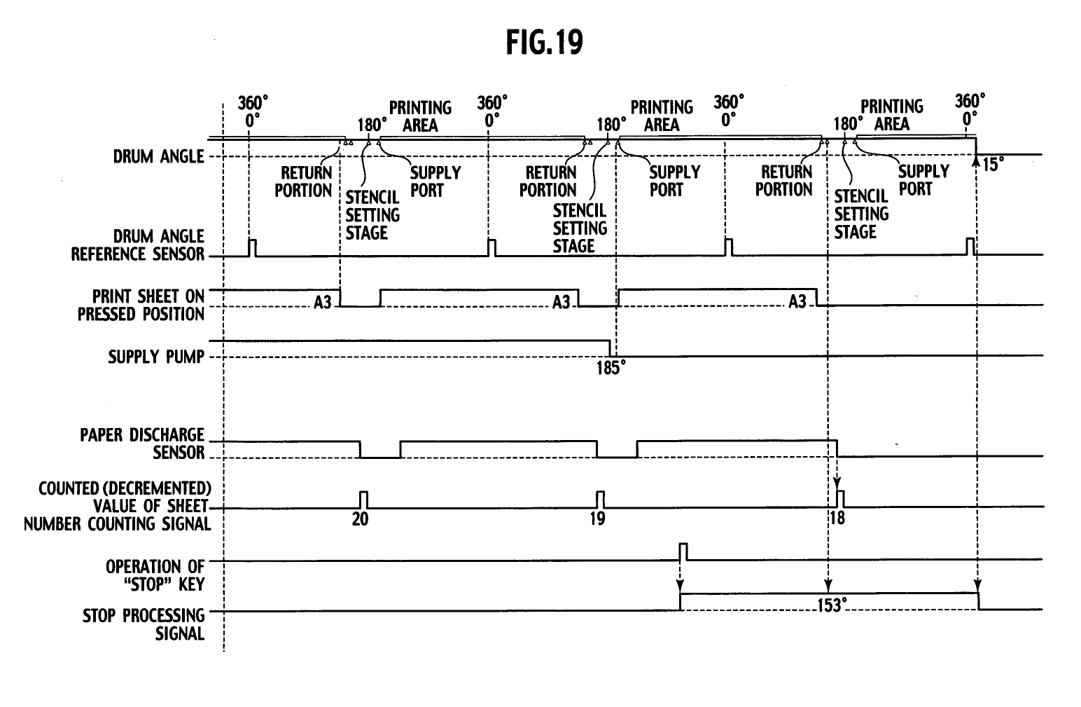

Next, the operation of stopping the rotation of the drum 26 is described based on a flowchart of FIG. 17 and time charts of FIG. 18 and FIG. 19. As shown in FIG. 18, when the paper discharge sensor 93 detects passage of the print sheets and a sheet number counter which counts the number of printed sheets by device of detection signals thereof decrements to zero during the printing operation (Step S1), a stop processing signal is set in a HI state. Then, by taking the next output of the drum angle reference sensor 30 as a reference, the drum 26 is stopped at the rotation angle of 15 degrees, that is, at the position where the ink supply port 55a is placed at the uppermost position of the outer peripheral wall 53 of the drum 26 (Steps S4 and S5).

As shown in FIG. 19, when the stop key of the operation panel 95 is operated during the printing operation (Step S2), the stop processing signal is set in the HI state. Then, the rotation angle of the drum 26 is awaited to pass through 145 degrees (printing-completed position) (Step S3). By taking the next output of the drum angle reference sensor 30 as a reference, the drum 26 is stopped at the rotation angle of 15 degrees, that is, at the position where the ink supply port 55a is placed at the uppermost position of the outer peripheral wall 53 of the drum 26 (Steps S4 and S5).

As described above, in the stencil printing machine of this second embodiment, at the rotation stop position of the drum 26, the ink supply port 55a is located above a liquid level of the ink in the supply tank 57. Accordingly, the ink 56 in the supply tank 57 never flows out of the ink supply port 55a under the own weight thereof. Hence, the inside of the machine is not contaminated by the ink 56 which flows out of the ink supply port 55a after the rotation of the drum 26 is stopped. Moreover, if a configuration is adopted so that the ink supply port 55a is always stopped at the uppermost position of the outer peripheral wall 53 of the drum 26 as in this second embodiment, brought is an advantage in that it is not necessary to install an ink level sensor 98 as in a modification example to be described later.

In this second embodiment, the ink supplying device 54B including the supply tank 57 is placed in the drum 26, and accordingly, the stencil printing machine can be made compact. Moreover, all the parts of the ink supplying device 54B are housed in the drum 26, and accordingly, a detachment of the drum 26 is not accompanied with a detachment of an ink supply passage. Therefore, it is not necessary to take measures for preventing the ink leakage. Furthermore, the ink supply passage is shortened to reduce flow resistance, and efficiency of supplying the ink is increased. Accordingly, the supply pump 58 of which performance is low is sufficient.

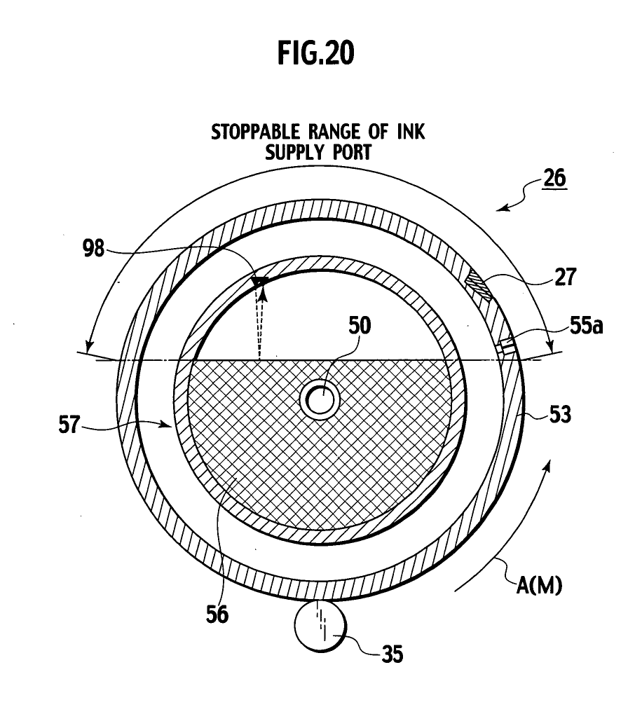

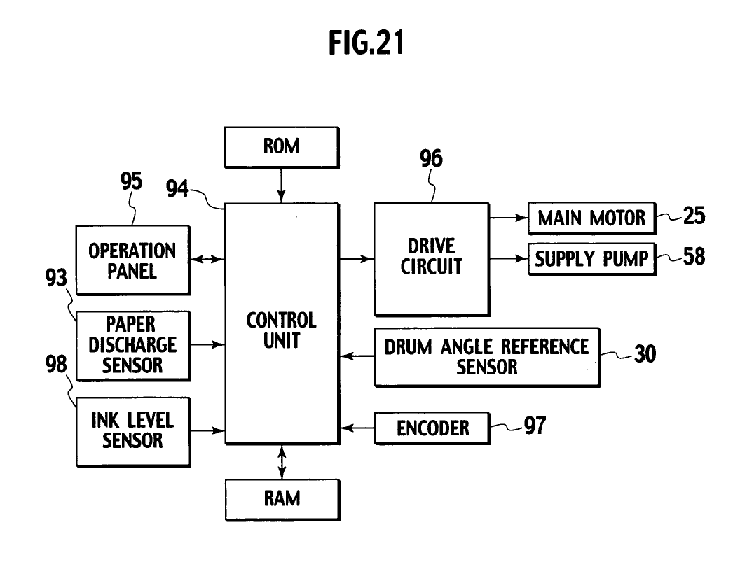

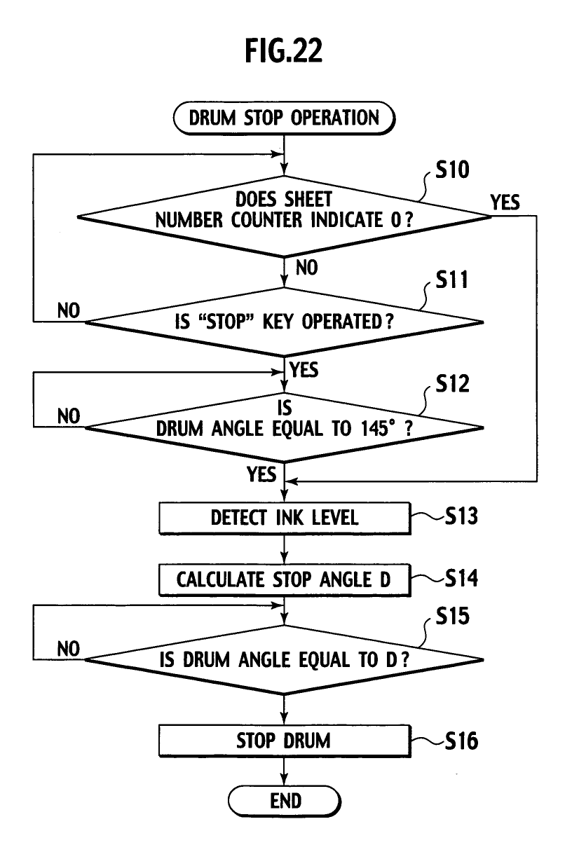

FIG. 20 to FIG. 22 show the modification example of the second embodiment. FIG. 20 is a cross-sectional view of a drum, FIG. 21 is a circuit block diagram of principal portions of a control system, and FIG. 22 is a flowchart of operations when rotation of the drum is stopped.

When this modification example is compared with the second embodiment in FIG. 20 to FIG. 22, this modification example is different from the second embodiment in that the ink level sensor 98 is provided in the supply tank 57 and in the control contents when the drum is stopped. Other configurations of this modification example are the same as those of the second embodiment. Accordingly, the same reference numerals are assigned to the same constituent portions, and detailed description thereof is omitted.

Specifically, the ink level sensor detects the liquid level of the ink in the supply tank 57, and outputs information thus detected to the control unit 94. The control unit 94 can calculate a rotation stop angle D (stoppable range of the ink supply port 55a in FIG. 20) at which the ink supply port 55a is located above the liquid level of the ink in the supply tank 57 from the information of the liquid level of the ink.

Next, the operation of stopping the rotation of the drum 26 is described based on the flowchart of FIG. 22. As shown in FIG. 22, when the paper discharge sensor 93 detects the passage of the print sheets and the sheet number counter which counts the number of printed sheets by device of the detection signals thereof decrements to zero during the printing operation (Step S10), the stop processing signal is set in a HI state. Immediately, the ink level information is detected (Step S13), and the stop angle D of the drum 26 can be calculated from the ink level information (Step S14). Then, by taking the next output of the drum angle reference sensor 30 as a reference, the drum 26 is stopped at a rotation position of the angle D, that is, at the position above the liquid level of the ink in the supply tank 57 (Steps S15 and S16).

Moreover, when the stop key of the operation panel 95 is operated during the printing operation (Step S11), the stop processing signal is set in the HI state. Then, the rotation angle of the drum 26 is awaited to pass through 145 degrees (printing-completed position) (Step S12). Immediately, the ink level information of the ink level sensor 98 is detected (Step S13), and the stop angle D of the drum 26 is calculated from the ink level information (Step S14). Then, by taking the next output of the drum angle reference sensor 30 as a reference, the drum 26 is stopped at the rotation position of D degrees, that is, at the position where the ink supply port 55a is placed at the position above the liquid level of the ink in the supply tank 57 (Steps S15 and S16).

As described above, also in this modification example of the second embodiment, at the rotation stop position of the drum 26, the ink supply pot 55a is located above the liquid level of the ink in the supply tank 57, and accordingly, the ink 56 in the supply tank 57 never flows out of the ink supply port 55a under the own weight thereof. Hence, the inside of the machine is not contaminated by the ink 56 which flows out of the ink supply port 55a after the rotation of the drum 26 is stopped.

Moreover, a configuration may be adopted to set the rotation stop angle D of the drum 26 so that the ink supply port 55a is located slightly above the liquid level of the ink in the supply tank 57 at the rotation stop position of the drum 26. With such a configuration, the supply tank 57 enters a state of being filled with the ink 56 just below the ink supply port 55a. Accordingly, at the time of starting the next printing, the ink 56 can be supplied rapidly from the ink supply port 55a to the outer peripheral wall 53.

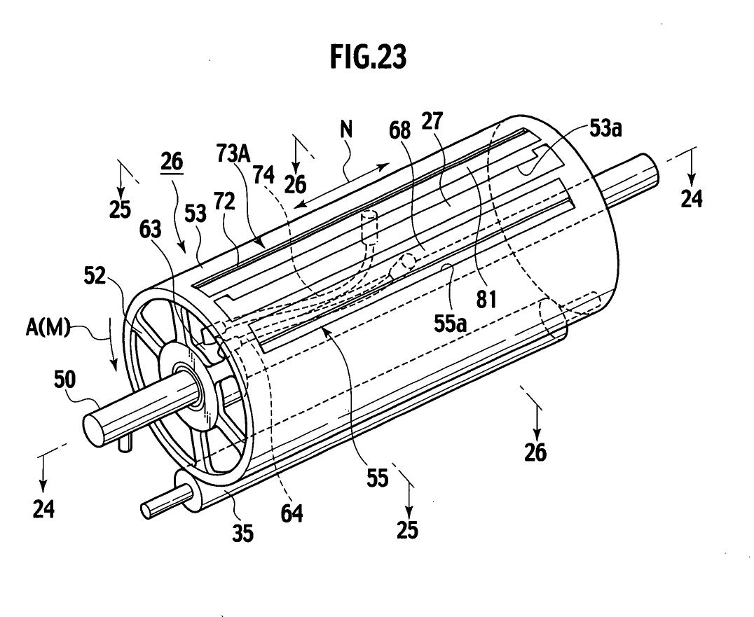

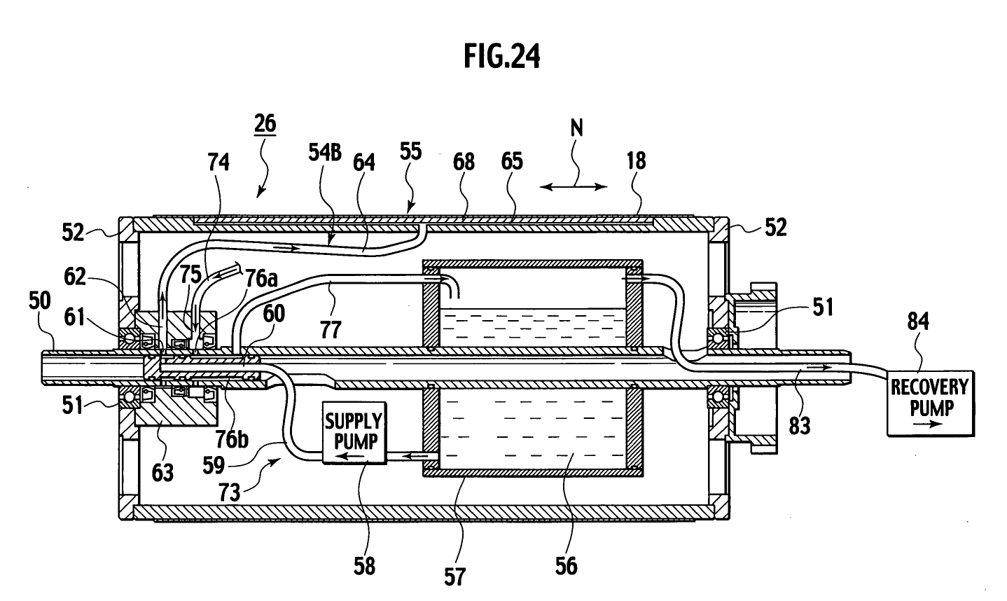

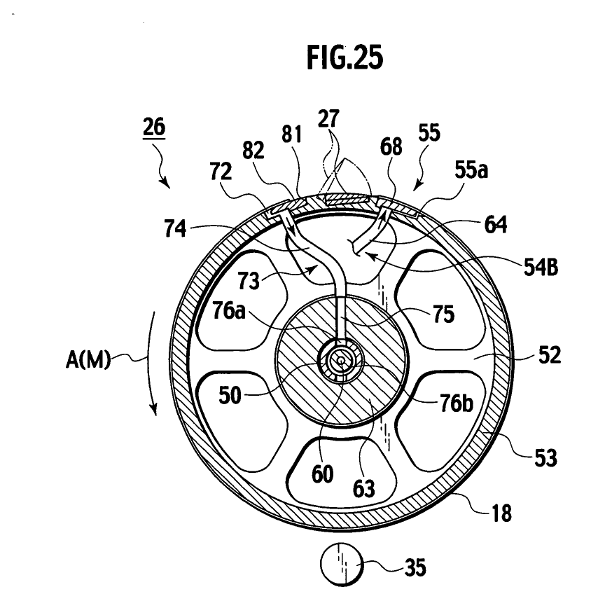

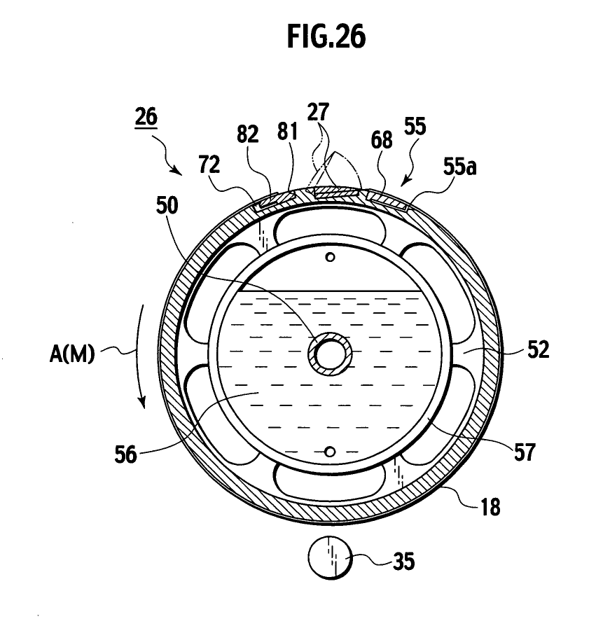

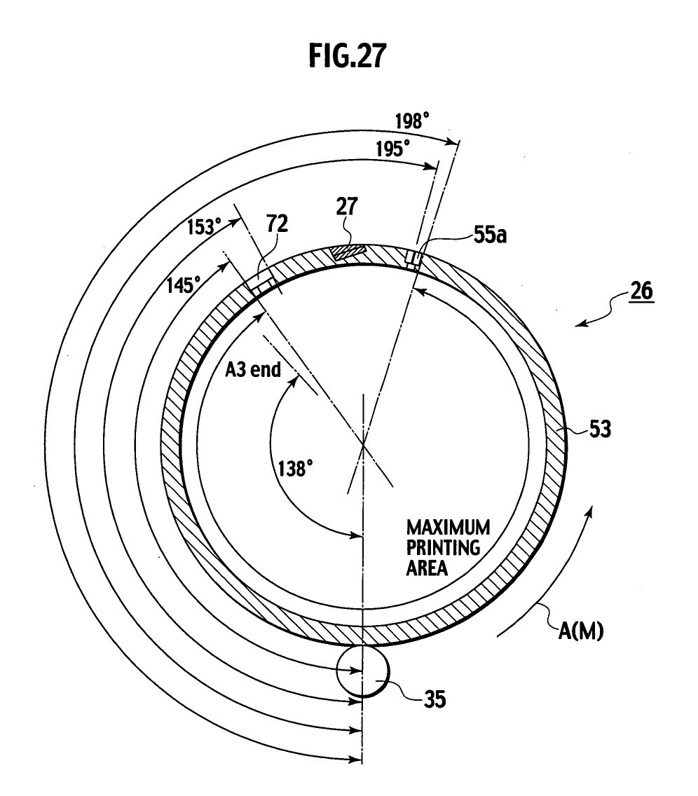

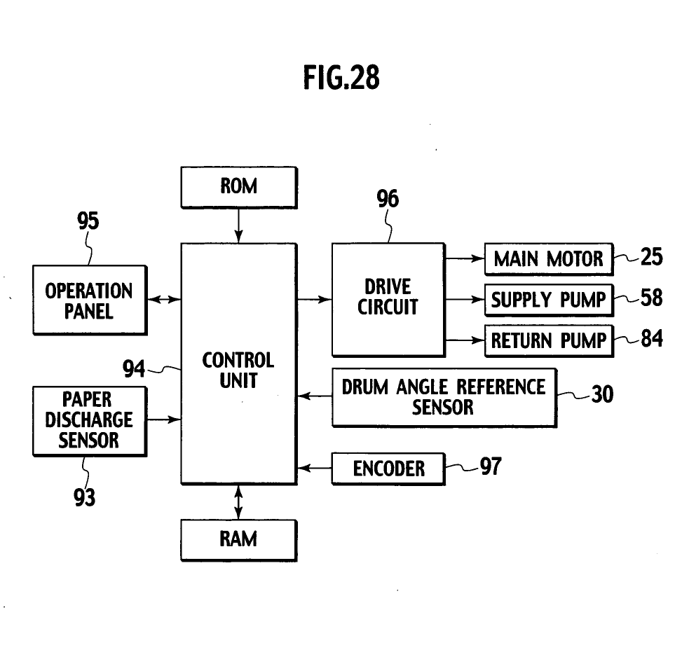

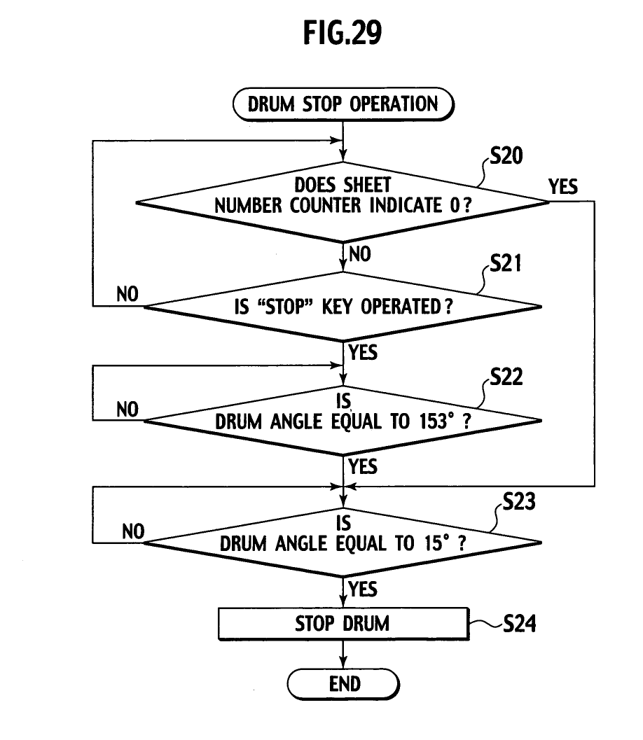

FIG. 23 to FIG. 29 show a third embodiment of the present invention. FIG. 23 is a perspective view of a drum, FIG. 24 is a cross-sectional view along a line 24-24 in FIG. 23, FIG. 25 is a cross-sectional view along a line 25-25 in FIG. 23, FIG. 26 is a cross-sectional view along a line 26-26 in FIG. 23, FIG. 27 is a cross-sectional view of the drum, showing a position where a rotation angle of the drum is 0 degree, FIG. 28 is a circuit block diagram of principal portions of a control system, and FIG. 29 is a flowchart of operations when rotation of the drum is stopped.

When this third embodiment is compared with the second embodiment in FIG. 23 to FIG. 29, this third embodiment is different from the second embodiment in that an ink recovery device 73 which recovers the ink 56 having leaked from the maximum printing area of the outer peripheral wall 53 is added and in a part of the control contents when the drum 26 is stopped. Other configurations of this third embodiment are the same as those of the second embodiment. Accordingly, the same reference numerals are assigned to the same constituent portions, and detailed description thereof is omitted.

Specifically, the ink recovery device 73 includes an ink recovery port 72 as an ink recovery portion provided at a position downstream of the maximum printing area of the outer peripheral wall 53 of the drum 26 in the printing direction, a third pipe 74 in which one end is made open to the ink recovery port 72, a rotary joint 63 to which the other end of the third pipe 74 is connected and in which a communication hole 75 is formed, a support shaft 50, a fourth pipe 77 in which one end is connected to the support shaft 50, a supply tank 57 as a recovery tank to which the other end of the fourth pipe 77 is connected, a fifth pipe 83 in which one end thereof is connected to an upper end of the supply tank 57 and which is guided to the outside of the drum 26 through the support shaft 50, and a recovery pump 84 of a vacuum pump type, which is connected to the other end of the fifth pipe 83 and reduces pressure in the supply tank 57. Here, regarding the support shaft 50, the rotary joint 63 is supported thereon so as to be freely rotatable, and a hole 76a to which the communication hole 75 is connectable and an ink passage 76b are formed in the inside thereof. The parts of the ink recovery device 73 except the recovery pump 84 and a part of the fifth pipe 83 are housed in the drum 26.

The ink recovery port 72 is formed by use of an ink recovery concave portion 81 formed on the outer peripheral wall 53, and a pipe fixing member 82 placed in the inside thereof. The rotary joint 63 is made to also function as one for the ink supplying device 54. The support shaft 50 is also used as one for an ink passage of the ink supplying device 54, and accordingly, adopts a structure of a double pipe. The recovery pump 84 is driven in most of the processes of the printing operation, and recovers, to the supply tank 57, the ink 56 having leaked from the maximum printing area of the outer peripheral wall 53.

Next, a control system is briefly described. As shown in FIG. 28, a control unit 94 receives a command signal from an operation panel 95 and sensor outputs from the paper discharge sensor 93, the drum angle reference sensor 30 and the like, and drives the main motor 25, the supply pump 58 and the like through a drive circuit 96 in order to execute the printing operation, the stencil making operation, the stencil disposal operation and the like based on the signals thus received. Moreover, when the rotation stop operation of the drum 26 is selected, a flow shown in FIG. 29 is executed. Control contents when the rotation is stopped are described below in paragraphs which describe functions of this embodiment.

Moreover, as in the first embodiment, the control unit 94 can detect the rotation angle of the drum 26 based on the sensor output of the drum angle reference sensor 30 and an output of an encoder 97. With regard to the rotation angle of the drum 26, a drum position shown in FIG. 27 shows a reference position of which angle is 0 degree. At a rotation position of 145 degrees, an end position of the maximum printing area is opposed to the pressure roller 35. At a rotation position of 153 degrees, an end position of the ink recovery port 72 is opposed to the pressure roller 35. At a rotation position of 195 degrees, the ink supply port 55a is opposed to the pressure roller 35. At a rotation position of 15 degrees, the ink supply port 55a is placed at the uppermost position of the outer peripheral wall 53 of the drum 26.

Next, the operation of stopping the rotation of the drum 26 is described based on the flowchart of FIG. 29.

As shown in FIG. 29, when the paper discharge sensor 93 detects the passage of the print sheets and the sheet number counter which counts the number of printed sheets by device of the detection signals thereof decrements to zero during the printing operation (Step S20), the stop processing signal is set in a HI state. Then, by taking the next output of the drum angle reference sensor 30 as a reference, the drum 26 is stopped at the rotation position of 15 degrees, that is, at the position where the ink supply port 55a is placed at the uppermost position of the outer peripheral wall 53 of the drum 26 (Steps S23 and S24).

Moreover, when the stop key of the operation panel 95 is operated during the printing operation (Step S21), the stop processing signal is set in the HI state. Then, the rotation angle of the drum 26 is awaited to pass through 153 degrees (end position of the ink recovery port 72) (Step S22). By taking the next output of the drum angle reference sensor 30 as a reference, the drum 26 is stopped at the rotation angle of 15 degrees, that is, at the position where the ink supply port 55a is placed at the uppermost position of the outer peripheral wall 53 of the drum 26 (Steps S23 and S24).

As described above, in the stencil printing machine of this third embodiment, at the rotation stop position of the drum 26, the ink supply port 55a is located above the liquid level of the ink in the supply tank 57. Accordingly, the ink 56 in the supply tank 57 never flows out of the ink supply port 55a under the own weight thereof. Hence, the inside of the machine is not contaminated by the ink 56 which flows out of the ink supply port 55a after the rotation of the drum 26 is stopped.

In this third embodiment, most of the parts of the ink supplying device 54B and the ink recovery device 73 are housed in the drum 26, and accordingly, the stencil printing machine can be made compact. Moreover, the ink supply passage is shortened to reduce the flow resistance, and the efficiency of supplying the ink is increased. Accordingly, the supply pump 58 of which performance is low is sufficient.

In this third embodiment, the ink 56 thus recovered is recovered into the supply tank 57 of the ink supplying device 54. Accordingly, the recovered ink 56 can be automatically used for the next printing and after.

Note that, though only the supply tank 57 of the ink supplying device 54 is placed in the drum 26 because the supply tank 57 is used as the recovery tank, a configuration may be adopted so as to individually house the supply tank 57 and the recovery tank in the drum 26.

In this third embodiment, one of the vacuum pump type is adopted as the recovery pump 84, and accordingly, a configuration is adopted so that the recovery pump 84 is placed outside the drum 26. However, if one of a trochoid pump type, which is interposed in the fourth pipe 77 and can suction the ink 56 in the ink recovery port 72 into the supply tank 57, is adopted as the recovery pump, the recovery pump 84 can be placed inside the drum 26. Then, if all the parts of the ink recovery device 73 are housed in the drum 26, the detachment of the drum 26 is not accompanied with the detachment of the ink supply passage. Therefore, it is not necessary to take measures for preventing the ink leakage. Moreover, the ink supply passage is shortened to reduce the flow resistance, and efficiency of recovering the ink is increased. Accordingly, brought is an advantage in that the recovery pump 84 of which performance is low is sufficient.

1. A stencil printing machine, comprising:
a drum which is freely rotatable and has an outer peripheral wall formed of an ink impermeable member, in which a stencil sheet is mounted on a surface of the outer peripheral wall;
an ink supply device which has an ink supply port provided on the outer peripheral wall of the drum and has a supply tank storing an ink, and supplies the ink from the ink supply port to the surface of the outer peripheral wall, the ink being guided from the supply tank; and
a pressure roller which presses a print medium fed thereto to the outer peripheral wall,
wherein the supply tank is placed below a lowermost position of the outer peripheral wall of the drum.

2. The stencil printing machine according to claim 1,
wherein the ink supply device supplies the ink between the outer peripheral wall and the stencil sheet.

3. A stencil printing machine, comprising:
a drum which is freely rotatable and has an outer peripheral wall formed of an ink impermeable member, in which a stencil sheet is mounted on a surface of the outer peripheral wall;
an ink supply device which has an ink supply port provided on the outer peripheral wall of the drum and has a supply tank storing an ink, and supplies the ink from the ink supply port to the surface of the outer peripheral wall, the ink being guided from the supply tank; and
a pressure roller which presses a print medium fed thereto to the outer peripheral wall,
wherein a position where the ink supply port is located above a liquid level of the ink in the supply tank is set at a rotation stop position of the drum.

4. The stencil printing machine according to claim 3,
wherein the rotation stop position of the drum is set at a position where the ink supply port is located slightly above the liquid level of the ink in the supply tank.

5. The stencil printing machine according to claim 3, further comprising:
an ink level sensor which detects the liquid level of the ink in the supply tank; and
a control unit which stops rotation of the drum so that the ink supply port is located above the liquid level of the ink in the supply tank based on detection information of the ink level sensor.

6. The stencil printing machine according claim 3,
wherein the supply tank is placed inside the drum.

7. The stencil printing machine according claim 3,
wherein the ink supply device supplies the ink between the outer peripheral wall and the stencil sheet.
